(19) United States
(12) Patent Application Publication
(10) Pub. No.: US 2026/0039380 A1
(43) Pub. Date: Feb. 5, 2026

(54) OPTICAL NETWORK MANAGEMENT DEVICE AND OPTICAL NETWORK MANAGEMENT METHOD

(71) Applicant: 1FINITY Inc., Kawasaki-shi (JP)

(72) Inventors: Shoichiro ODA, Fuchu (JP); Setsuo YOSHIDA, Inagi (JP); KAZUYUKI TAJIMA, Yokosuka (JP); Motohiko ETO, Kawasaki (JP)

(73) Assignee: 1FINITY Inc., Kawasaki-shi (JP)

(21) Appl. No.: 19/354,273

(22) Filed: Oct. 9, 2025

Related U.S. Application Data
(63) Continuation of application No. PCT/JP2024/004723, filed on Feb. 13, 2024.

(30) Foreign Application Priority Data
Apr. 14, 2023 (JP) 2023-066541

(51) Int. Cl. H04B 10/077

(52) U.S. Cl. CPC H04B 10/0775; H04B 10/0779

(57) ABSTRACT

An optical network management device includes a collector that collects first information representing a waveform of an intensity of first signal light that is transmitted from an optical transmitter based on input of an electrical data signal and is received by an optical receiver of an optical transmission device via an optical transmission line, a generator that generates second information representing a waveform of an intensity of virtual second signal light corresponding to the first signal light by calculating electric field information corresponding to the data signal based on the data signal and an optical network model representing a characteristic of an optical network including the optical transmitter, the optical transmission line, and the optical transmission device, and an estimator that estimates the characteristic of the optical network by calculating a parameter of the optical network model based on the first information and the second information.

### CROSS-REFERENCE TO RELATED APPLICATION

This application is a continuation application under 35 USC 111(a) of prior International Patent Application No. PCT/JP2024/004723, filed on Feb. 13, 2024, which claims the benefit of priority of Japanese Patent Application No. 2023-066541 filed on Apr. 14, 2023, the entire contents of which are incorporated herein by reference.

### FIELD

A certain aspect of the present embodiments relates to an optical network management device and an optical network management method.

### BACKGROUND

An optical fiber of, for example, several tens of kilometers to several thousands of kilometers extends between an optical transmitter and an optical receiver, as an optical transmission line. A repeat node (hereinafter referred to as an optical transmission device) such as a reconfigurable optical add/drop multiplexer (ROADM) device is disposed in the middle of the optical transmission line. The optical transmission line is divided into a plurality of spans (sections) by the optical transmission device (for example, see Japanese Laid-Open Patent Application No. 2018-133725, and F. N. Hauske et al., “Optical Performance Monitoring in Digital Coherent Receivers”, IEEE Journal of Lightwave Technology, Vol 27, No. 16, pp. 3623-3631, 2009).

The optical transmitter includes, for example, a digital-to-analog converter (DAC), a driver amplifier, a modulator, a light source (specifically, a laser light source), and the like. The optical receiver is, for example, a digital coherent receiver, and includes a 90-degree hybrid circuit, a photodiode, a light source, an analog to digital converter (ADC), and the like (for example, see Japanese Laid-Open Patent Application No. 2022-060607).

The components of an optical network such as an optical transmitter, an optical transmission device, and an optical fiber have characteristics of a linear response (for example, frequency characteristics) and a nonlinear response (for example, saturation characteristics of a signal voltage) that are specific to the components. These characteristics limit the quality of the signal light in the optical network. In order to compensate for the deterioration of the quality of the signal light, it is necessary to estimate the characteristics of the linear response and the nonlinear response. The linear response and the nonlinear response are greatly different depending on the individual of the optical transmitter, the optical transmission device, the optical fiber or the like, environment, and parameters. Therefore, for example, it is assumed that parameters of the linear response and the nonlinear response are estimated and the deterioration of the quality is compensated (for example, International Publication Pamphlet No. WO2021/199317).

### SUMMARY

According to an aspect of the present disclosure, there is provided an optical network management device including: a collector that collects first information representing a waveform of an intensity of first signal light that is transmitted from an optical transmitter based on input of an electrical data signal and is received by an optical receiver of an optical transmission device via an optical transmission line; a generator that generates second information representing a waveform of an intensity of virtual second signal light corresponding to the first signal light by calculating electric field information corresponding to the data signal based on the data signal and an optical network model representing a characteristic of an optical network including the optical transmitter, the optical transmission line, and the optical transmission device; and an estimator that estimates the characteristic of the optical network by calculating a parameter of the optical network model based on the first information and the second information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating an example of the functional configuration of an optical network management device.

FIG. 2 is a block diagram illustrating an example of a modulation unit, an optical transmission device, and a model unit.

FIG. 3 is a block diagram illustrating an example of the hardware configuration of the optical network management device.

FIG. 4 is a flowchart illustrating an example of the operation of the optical network management device.

FIG. 5A is a block diagram illustrating an example of an optical transmission device according to an embodiment.

FIG. 5B is a block diagram illustrating an example of an optical transmission device according to a comparative example.

FIG. 6 is a block diagram illustrating another example of the functional configuration of the optical network management device.

FIG. 7 is a block diagram illustrating another example of the modulation unit, the optical transmission device, and the model unit.

FIG. 8A is a transfer function of polarization rotation in an optical fiber model.

FIG. 8B is a transfer function of a polarization dependent loss in the optical fiber model and an optical transmission device model.

FIG. 8C is a transfer function of filtering in the optical transmission device model.

FIG. 9 is a flowchart illustrating another example of the operation of the optical network management device.

FIG. 10 is a diagram illustrating an example of comparison between first information, and second information based on an optical transmitter model.

FIG. 11 is a diagram illustrating an example of comparison between the first information, and the second information based on the optical fiber model.

FIG. 12 is a diagram illustrating an example of comparison between the first information, and the second information based on the optical transmission device model.

FIG. 13 is a diagram illustrating another example of comparison between the first information, and the second information based on the optical transmission device model.

### DETAILED DESCRIPTION

When parameters are estimated by an optical transmission device including components such as a 90-degree hybrid circuit, a photodiode, a light source, and an ADC, power consumption may increase. For example, in the estimation of the parameters, the generation of the electric field information using the above-described components is required, but each component consumes power when the electric field information is generated. Accordingly, when the parameters are estimated by the optical transmission device, there is a possibility that power consumption increases.

Therefore, according to one aspect, it is an object to provide an optical network management device and an optical network management method that estimate characteristics of an optical network using an optical transmission device with reduced power consumption.

Hereinafter, embodiments of the present disclosure will be described with reference to the drawings.

### First Embodiment

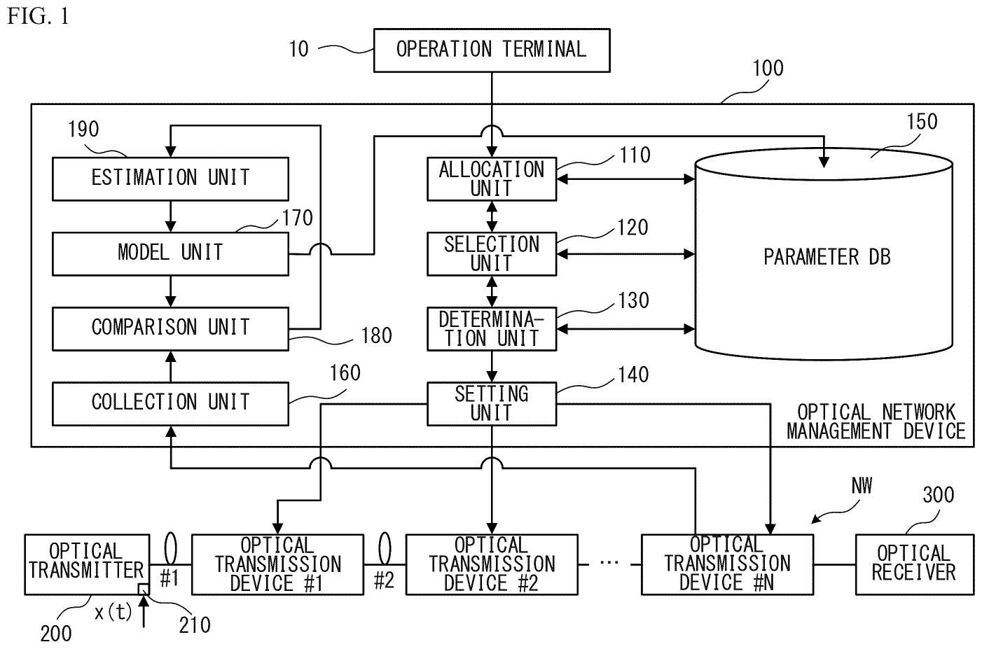

As illustrated in FIG. 1, an optical network management device 100 is connected to an optical network NW. The optical network management device 100 manages the optical network NW. The optical network NW includes an optical transmitter 200, a plurality of optical fibers #1, #2, a plurality of optical transmission devices #1, #2, #N, and an optical receiver 300. The optical fibers #1, #2, and the like are examples of optical transmission lines. The optical transmission device #N is an example of a specific optical transmission device.

The optical transmitter 200 is disposed at the most upstream of the optical network NW. The optical receiver 300 is disposed at the most downstream of the optical network NW. The optical transmitter 200 is connected to the optical transmission device #1 via the optical fiber #1. The optical transmission device #1 is connected to the optical transmission device #2 via the optical fiber #2. The connection form from the optical transmission device #2 to the optical transmission device #N is basically the same as the connection form between the optical transmission device #1 and the optical transmission device #2, and thus detailed description thereof will be omitted. The optical transmission device #N is connected to the optical receiver 300 via an optical fiber.

The optical transmitter 200 transmits signal light (for example, wavelength multiplexed signal light) corresponding to an electrical known data signal x(t) including a time-series training signal. More specifically, when the data signal x(t) is input to the optical transmitter 200, the optical transmitter 200 generates and transmits signal light corresponding to the data signal x(t) by a modulation unit 210 described later. The signal light transmitted from the optical transmitter 200 is guided to the optical receiver 300 via the optical fiber #1, the optical transmission device #1, the optical fiber #2, the optical transmission device #2, and the optical transmission device #N. Thus, the optical receiver 300 receives the signal light.

The optical network management device 100 includes an allocation unit 110, a selection unit 120, a determination unit 130, a setting unit 140, and a parameter database (DB) 150. The optical network management device 100 includes a collection unit 160, a model unit 170, a comparison unit 180, and an estimation unit 190.

The allocation unit 110 receives a connection request for the optical transmitter 200 and the optical receiver 300, which is transmitted from an operation terminal 10. The operation terminal 10 includes, for example, a personal computer (PC). When the connection request is received, the allocation unit 110 searches the parameter DB 150 and selects an unallocated (or vacant) wavelength that is not currently in operation from among the plurality of wavelengths. After selecting the wavelength, the allocation unit 110 allocates the wavelength to the transmission of the data signal x(t) from the optical transmitter 200 to the optical receiver 300. The allocation unit 110 selects a transmission path of the data signal x(t) together with the allocation of the wavelength.

When the selection unit 120 detects the end of the allocation of wavelengths and the selection of the transmission path by the allocation unit 110, the selection unit 120 searches the parameter DB 150 and selects a signal type that is efficient for the transmission of signal light. For example, the selection unit 120 selects an optical modulating method such as 64QAM (Quadrature Amplitude Modulation) or QPSK (Quadrature Phase-Shift Keying) as the signal type. The selection unit 120 selects a baud rate (modulated speed) such as 64G baud or 128G baud as the signal type. Further, the selection unit 120 selects a bit rate (transmission speed) such as 200G bps or 400G bps as the signal type.

When the determination unit 130 detects the end of the selection of the signal type by the selection unit 120, the determination unit 130 searches the parameter DB 150 and determines whether the transmission is actually possible based on the selected signal type. When the transmission is impossible, the determination unit 130 notifies the operation terminal 10 that the transmission is impossible via the selection unit 120 and the allocation unit 110. If the transmission is possible, the determination unit 130 notifies the setting unit 140 of a transmission condition. The transmission condition of which the determination unit 130 notifies the setting unit 140 includes the wavelength allocated by the allocation unit 110, the selected transmission path, and the signal type selected by the selection unit 120. The setting unit 140 sets the transmission condition notified from the determination unit 130 into the optical transmission devices #1, #2, #N.

The collection unit 160 collects information indicating the waveform of the intensity of the signal light from the optical transmission device #N as first information. That is, the collection unit 160 collects, as the first information, information indicating the waveform of the intensity of the signal light transmitted from the optical transmitter 200 and passing through the optical fibers #1, #2 . . . , and the optical transmission devices #1, #2, . . . , and #N−1.

The model unit 170 calculates electric field information corresponding to the data signal x(t) based on the data signal x(t) input to the optical transmitter 200 and a transfer function that expresses the characteristics (or the state) of the optical network NW by a mathematical model. Although details will be described later, the transfer function includes various parameters (for example, a polarization dependent loss PDL, a phase rotation amount θ of polarization rotation, and the like). The model unit 170 generates information representing a waveform of the intensity of virtual signal light corresponding to the signal light as second information by calculating the electric field information.

The comparison unit 180 compares the first information and the second information described above. The estimation unit 190 updates the parameter of the transfer function until the comparison result between the first information and the second information is equal to or less than a threshold value. When the comparison result is equal to or less than the threshold value, the estimation unit 190 stops the update and estimates the parameter of the transfer function based on the second information that has become equal to or less than the threshold value. When the parameter is estimated, the estimation unit 190 updates the parameter DB 150 based on the estimated parameter.

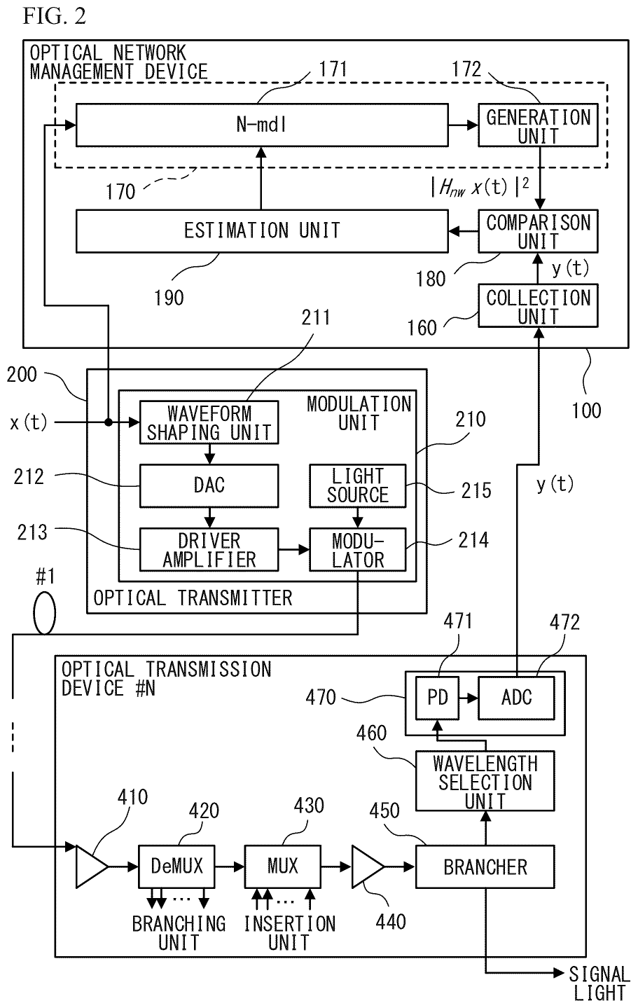

The optical transmitter 200, the optical transmission device #N, and the model unit 170 according to the first embodiment will be described in detail with reference to FIG. 2. The configurations of the optical transmission devices #1 and #2 are basically the same as the configuration of the optical transmission device #N, and thus detailed description thereof is omitted.

As illustrated in FIG. 2, the optical transmitter 200 includes the modulation unit 210. The modulation unit 210 includes a waveform shaping unit 211, a DAC (Digital Analogue Converter) 212, a driver amplifier 213, a modulator 214, and a light source 215. The waveform shaping unit 211 shapes the waveform of the input signal x(t) and outputs the shaped signal to the DAC 212. The DAC 212 converts the digital signal x(t) into an analog signal and outputs the analog signal to the driver amplifier 213.

The driver amplifier 213 amplifies the data signal x(t) and outputs the amplified data signal x(t) to the modulator 214. The modulator 214 generates signal light by modulating the laser light output from the light source 215 based on the data signal x(t), and transmits the signal light to the optical fiber #1. Thus, the signal light is guided to the optical transmission device #N via the optical fiber #1 and the like.

The optical transmission device #N includes a pre-stage optical amplifier 410, a demultiplexer 420, a multiplexer 430, a post-stage optical amplifier 440, a brancher 450, a wavelength selection unit 460, and a detection unit 470. The detection unit 470 includes a photodiode (PD) 471 and an analogue digital converter (ADC) 472. The demultiplexer 420 is an example of a branching filter or a demultiplexer. The PD 471 is an example of an optical receiver.

The signal light transmitted from the optical transmitter 200 is input to the pre-stage optical amplifier 410 of the optical transmission device #N via the optical fiber #1 or the like. The pre-stage optical amplifier 410 amplifies the signal light and outputs the amplified signal light to the demultiplexer 420. The demultiplexer 420 demultiplexes the signal light, outputs the signal light having a part of the wavelengths to a branching unit, and outputs the signal light having the remaining wavelengths to the multiplexer 430. The multiplexer 430 multiplexes the signal light output from the demultiplexer 420 and the signal light output from an insertion unit, and outputs the multiplexed signal light to the post-stage optical amplifier 440. The post-stage optical amplifier 440 amplifies the signal light and outputs the amplified signal light to the brancher 450.

The brancher 450 branches the signal light and guides the branched signal light to the wavelength selection unit 460. The brancher 450 may be implemented by, for example, an optical coupler. Further, instead of the brancher 450, a demultiplexer that demultiplexes the signal light and guides the signal light to the wavelength selection unit 460 may be adopted. The wavelength selection unit 460 selects one of a plurality of wavelengths included in the signal light, and outputs the signal light having the selected wavelength to the detection unit 470. The wavelength selection unit 460 may be implemented by, for example, an electronic circuit. The PD 471 of the detection unit 470 generates information representing the waveform of the intensity of the signal light. The ADC 472 converts the information generated by the PD 471 from the analog format to the digital format. The information converted into the digital format is collected as first information y(t) by the collection unit 160.

The model unit 170 included in the optical network management device 100 includes an optical network model (denoted as N-mdl) 171 and a generation unit 172. The optical network model 171 includes a transfer function H_{nw} that expresses the characteristics (or state) of the optical network NW by a mathematical model. The optical network model 171 calculates an output signal of the optical transmission device #N using the transfer function H_{nw}. The transfer function H_{nw} includes a parameter to be estimated. The transfer functions H_{nw} can be determined in advance by appropriately selecting various transfer functions H_{mod}, H_{fiber1}, Hₜᵣₐₙₛ₁, and the like, which will be described later. The transfer function H_{nw} can be associated with the elements constituting the optical network NW.

The optical network model 171 calculates electric field information of signal light transmitted from the optical transmitter 200 and output from the optical transmission device #N via the optical fiber #1, the optical transmission device #1, and the like, based on the data signal x(t) and the transfer function H_{nw}. The generation unit 172 generates, as second information |H_{nw}x(t)|², information indicating a waveform of the intensity of virtual signal light corresponding to the signal light output from the optical transmission device #N based on the electric field information, and outputs the second information |H_{nw}x(t)|² to the comparison unit 180. Accordingly, the comparison unit 180 can compare the first information y(t) collected by the collection unit 160 with the second information |H_{nw}x(t)|² output from the generation unit 172. When the comparison result becomes equal to or less than the threshold, the estimation unit 190 calculates and updates the parameter of the transfer function H_{nw} of the optical network model 171 based on the second information |H_{nw}x(t)|² that has become equal to or less than the threshold, thereby performing estimation.

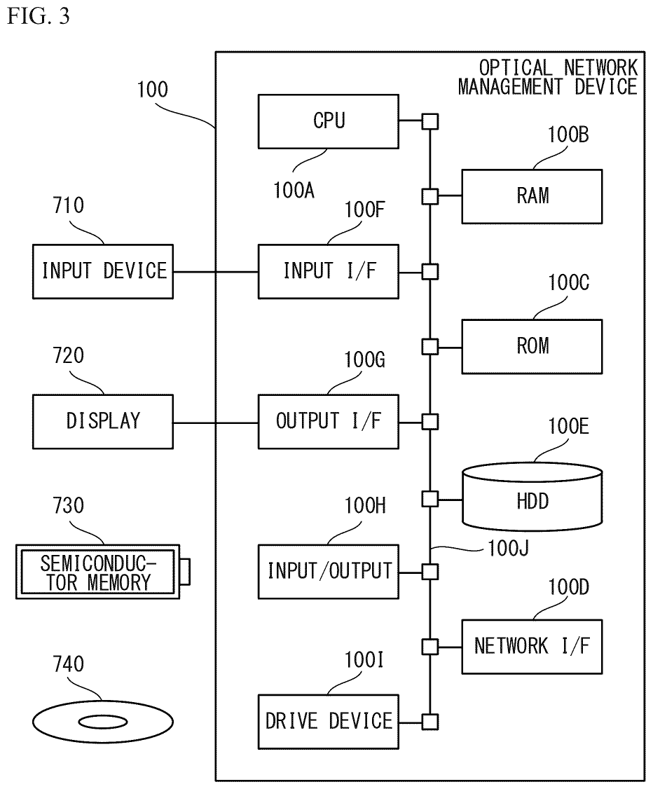

A hardware configuration of the optical network management device 100 will be described with reference to FIG. 3.

The optical network management device 100 includes a central processing unit (CPU) 100A as a processor, and a random access memory (RAM) 100B and a read only memory (ROM) 100C as a memory. The optical network management device 100 includes a network interface (I/F) 100D and a hard disk drive (HDD) 100E. A solid state drive (SSD) may be adopted instead of the hard disk drive (HDD) 100E.

The optical network management device 100 may include at least one of an input I/F 100F, an output I/F 100G, an input/output I/F 100H, and a drive device 100I, as necessary. The components from the CPU 100A to the drive device 100I are connected to each other by an internal bus 100J. That is, the optical network management device 100 may be implemented by a computer.

An input device 710 is connected to the input I/F 100F. Examples of the input device 710 include a keyboard, a mouse, and a touch panel. A display 720 is connected to the output I/F 100G. The display 720 may be, for example, a liquid crystal display. A semiconductor memory 730 is connected to the input/output I/F 100H. The semiconductor memory 730 may be, for example, a universal serial bus (USB) memory or a flash memory. The input/output I/F 100H reads an optical network management program stored in the semiconductor memory 730. The input I/F 100F and the input/output I/F 100H include, for example, USB ports. The output I/F100G includes, for example, a display port.

A portable recording medium 740 is inserted into the drive device 100I. The portable recording medium 740 may be a removable disk such as a compact disc (CD)-ROM or a digital versatile disc (DVD). The drive device 100I reads the optical network management program recorded in the portable recording medium 740. The network I/F 100D includes, for example, a LAN port, a communication circuit, and the like. The communication circuit includes one or both of a wired communication circuit and a wireless communication circuit. The network I/F 100D is connected to the optical transmitters 200 and the optical transmission devices #1, #2, . . . , #N.

The optical network management program stored in at least one of the ROM 100C, the HDD 100E and the semiconductor memory 730 is temporarily stored in the RAM 100B by the CPU 100A. The optical network management program recorded on the portable recording medium 740 is temporarily stored in the RAM 100B by the CPU 100A. The CPU 100A executes the stored optical network management program, so that the CPU 100A realizes various functions described later and executes an optical network management method including various processes described later. The optical network management program may be a program according to a flowchart described later.

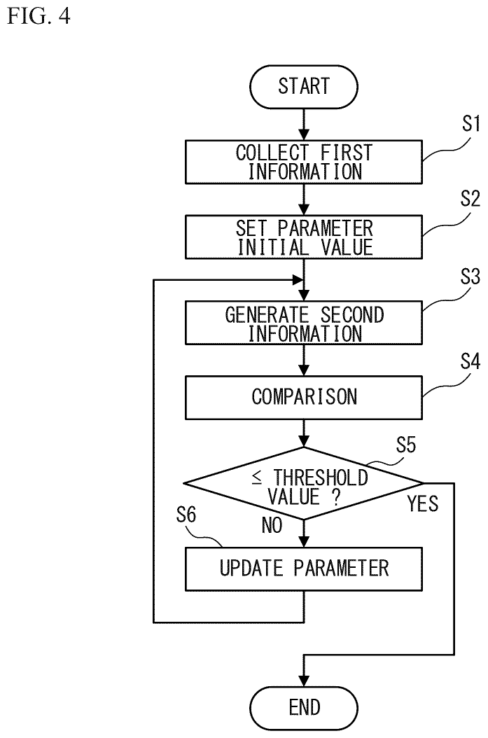

The operation of the optical network management device 100 according to the first embodiment will be described with reference to FIG. 4.

As illustrated in FIG. 4, first, the collection unit 160 collects the first information (step S1). More specifically, the collection unit 160 collects information generated by the optical transmission device #N as the first information. When the first information is collected, the estimation unit 190 sets parameter initial values (step S2). More specifically, the estimation unit 190 sets numerical values determined in the design of the optical network NW as the parameter initial values into the optical network model 171.

When the parameter initial values are set, the model unit 170 generates the second information (step S3). More specifically, the optical network model 171 generates electric field information based on the data signal x(t), and the generation unit 172 generates the second information based on the electric field information. When the second information is generated, the comparison unit 180 compares the first information collected by the collection unit 160 with the second information generated by the generation unit 172 (step S4), and determines whether a difference between the first information and the second information is equal to or less than a threshold value (step S5). That is, the determination by the comparison unit 180 can be expressed by the following determination formula.

$$< Determination Formula >$$

$$First information y ( t ) - second information {\vert {H}_{nw} x ( t ) \vert}^{2} \leq threahold value {Z}_{t h}$$

When the difference as the comparison results of the first information y(t) and the second information |H_{nw}x(t)|² is more than the threshold value Zₜₕ (step S5: NO), the estimation unit 190 updates the parameter of the transfer functions H_{nw} (step S6) and requests the model unit 170 to execute the process of step S3. Accordingly, the model unit 170 generates the second information again using the transfer function H_{nw} including the updated parameter, and the comparison unit 180 compares the first information with the second information. As described above, when there is a deviation larger than the threshold value in the difference between the first information and the second information, the optical network management device 100 repeats the process of updating the parameter until the difference becomes equal to or smaller than the threshold value, thereby sufficiently suppressing the deviation.

When the difference as the comparison result of the first information y(t) and the second information |H_{nw}x(t)|² is equal to or less than the reference value Zₜₕ (step S5: YES), the estimation unit 190 ends the process. That is, if the parameter is the last updated parameter, it can be recognized that the deviation between the first information and the second information is sufficiently suppressed. In this way, the estimation unit 190 can estimate the parameter of the optical network model 171 by updating the parameter included in the transfer function H_{nw} of the optical network model 171.

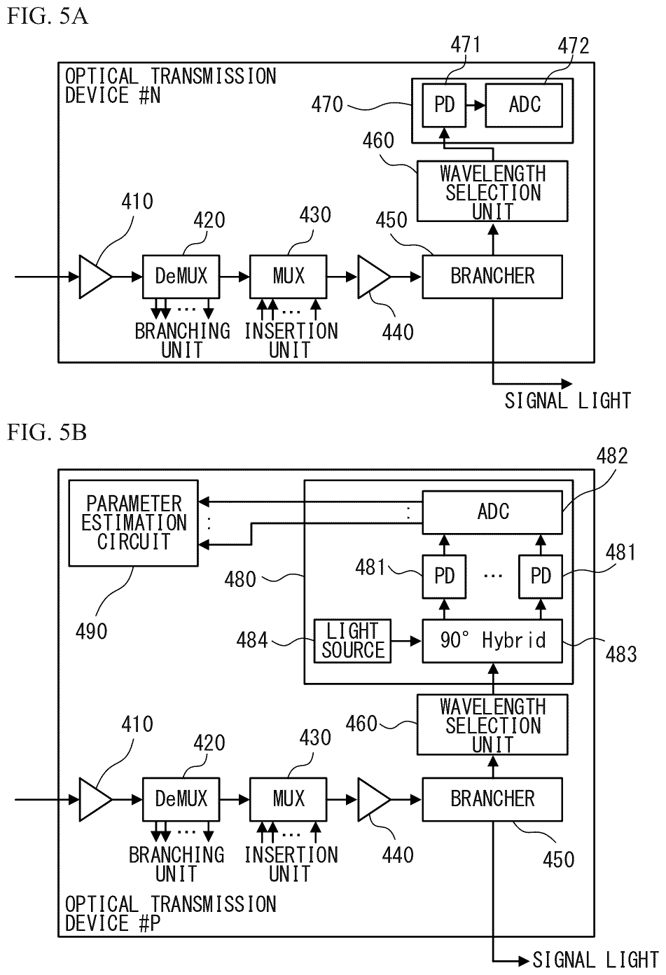

As a result, as illustrated in FIG. 5A, in the optical transmission device #N according to the first embodiment, the parameter of the optical network model 171 can be estimated by the simple detection unit 470 including one PD 471 and one ADC 472. For example, as illustrated in FIG. 5B, when the optical transmission device #P according to the comparative example is provided with a digital coherent reception type channel monitor 480 and a parameter estimation circuit 490, the power consumption of the optical transmission device #P increases. This is because the channel monitor 480 includes four PDs 481, an ADC 482, and a 90-degree hybrid circuits 483 and a light source 484 as components.

For example, the four PDs 481 are used for the I and Q components of the X polarization of the signal light and the I and Q components of the Y polarization of the signal light, and each of the four PDs 481 consume the power. Each of the 90-degree hybrid circuit 483 and the light source 484 also consumes the power. Therefore, when such a channel monitor 480 is provided in the optical transmission device #P, the power consumption increases compared to the optical transmission device #N including the detection unit 470 including the single PD 471. In other words, the optical transmission device #N has a smaller number of components than the optical transmission device #P, and thus can reduce the power consumption. In addition, since the optical transmission device #N has a smaller number of components than the optical transmission device #P, the manufacturing cost of the optical transmission device #N may be reduced. As described above, the optical network management device 100 according to the first embodiment may estimate the characteristics of the optical network NW by updating the parameter of the optical network model 171 using the optical transmission device #N with reduced power consumption.

### Second Embodiment

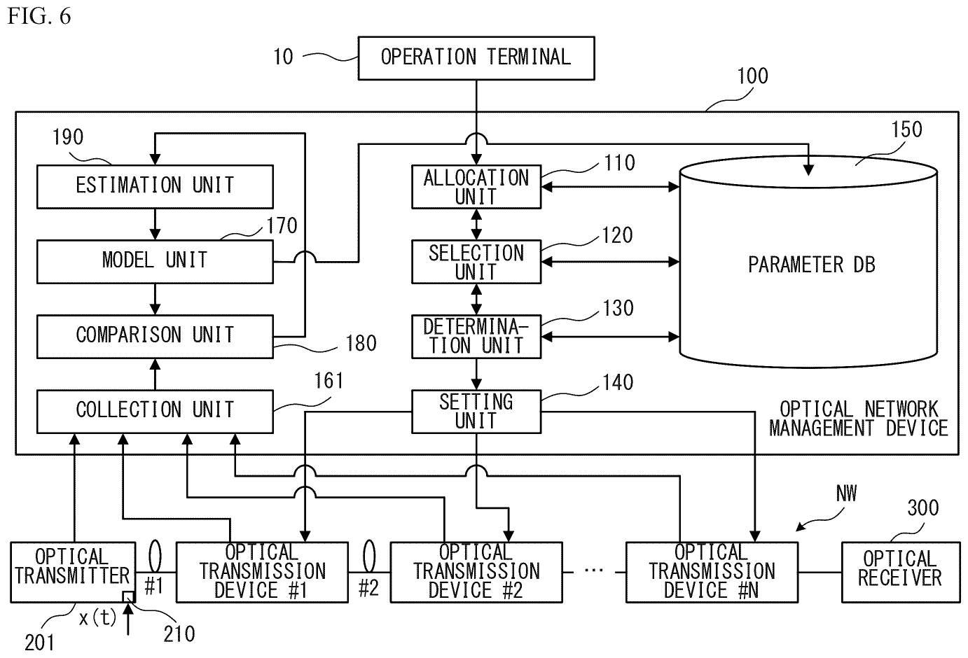

Next, the optical network management device 100 according to a second embodiment will be described with reference to FIGS. 6 to 13.

As illustrated in FIG. 6, unlike the first embodiment, a collection unit 161 according to the second embodiment collects the first information from all of an optical transmitter 201 and the optical transmission devices #1, #2, #N. Although details will be described later, the collection unit 161 collects the first information from all of the optical transmitter 201 and the optical transmission devices #1, #2, #N and updates the parameter in a stepwise manner, and thus the estimation accuracy of the parameter is improved as compared with the case of the first embodiment.

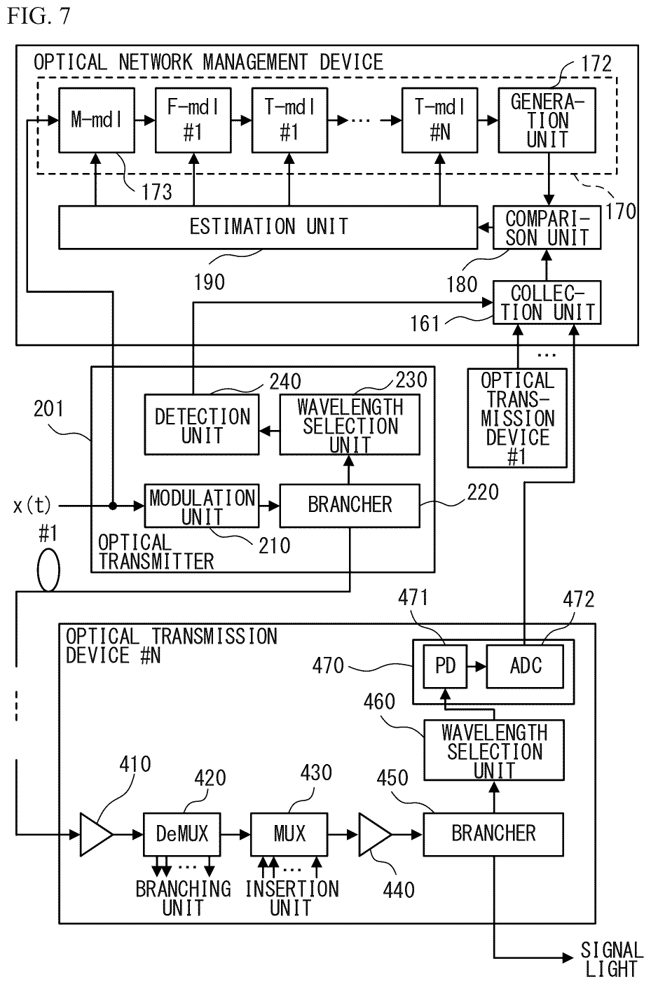

Details of the optical transmitter 201 and the model unit 170 according to the second embodiment will be described with reference to FIG. 7. The configuration of the optical transmission device #N according to the second embodiment is basically the same as the configuration of the optical transmission device #N according to the first embodiment, and thus detailed description thereof will be omitted.

As illustrated in FIG. 7, the optical transmitter 201 according to the second embodiment further includes a brancher 220, a wavelength selection unit 230, and a detection unit 240 in addition to the modulation unit 210 described in the first embodiment. The brancher 220 branches the signal light and guides the branched signal light to the wavelength selection unit 230. The brancher 220 may be implemented by, for example, an optical coupler.

The wavelength selection unit 230 selects one of a plurality of wavelengths included in the signal light, and outputs the signal light having the selected wavelength to the detection unit 240. The detection unit 240 generates information representing the waveform of the intensity of the signal light, and converts the generated information from the analog format to the digital format. Note that the detection unit 240 can be realized by a PD and an ADC, similarly to the detection unit 470.

The model unit 170 of the optical network management device 100 includes an optical transmitter model (denoted as M-mdl) 173, a plurality of optical fiber models (denoted as F-mdl) #1, #2, . . . , a plurality of optical transmission device models (denoted as T-mdl) #1, #2, . . . , #N, and the generation unit 172 described in the first example embodiment. The optical fiber models #1, #2, . . . are examples of optical transmission line models.

The optical transmitter model 173, the optical fiber models #1, #2, . . . , and the optical transmission device models #1, #2, . . . , and #N are included in the optical network model 171. The order of the optical transmitter model 173, the plurality of optical fiber models #1, #2, . . . , and the optical transmission device models #1, #2, . . . , and #N corresponds to the arrangement relationship of the optical transmitter 201, the plurality of optical fibers #1, #2, . . . , and the optical transmission devices #1, #2, . . . , and #N. That is, the optical network model 171 includes the optical transmitter model 173, a first combination of the optical fiber model #1 and the optical transmission device model #1, a second combination of the optical fiber model #2 and the optical transmission device model #2, . . . , and an N-th combination of the optical fiber model #N and the optical transmission device model #N.

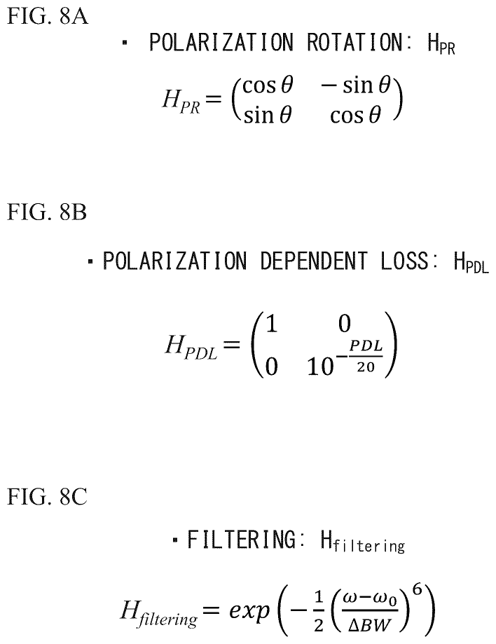

The optical transmitter model 173 includes a transfer function H_{mod} that expresses the characteristics (or state) of the optical transmitter 201 by a mathematical model. The optical transmitter model 173 calculates the output signal of the optical transmitter 201 using the transfer function H_{mod}. The transfer function H_{mod} includes a parameter to be estimated. For example, the transfer function H_{mod} includes a delay amount Δτ with respect to the data signal x(t) as a parameter. For the parameter included in the transfer function H_{mod}, for example, Japanese Laid-Open Patent Application No. 2022-060607 can be referred to. The fiber model #1 includes a transfer function H_{fiber1} that expresses the characteristics (or states) of the fiber #1 by a mathematical model. The fiber model #1 uses the transfer functions H_{fiber1} to calculate an output signal of the fiber #1. The optical fiber model #2 and the subsequent optical fiber models described later are basically the same as the optical fiber model #1, and thus detailed description thereof will be omitted. As illustrated in FIGS. 8A and 8B, the transfer functions H_{PR} and H_{PDL} can be selectively adopted as the transfer functions H_{fiber1}. For example, as illustrated in FIG. 8A, the transfer function H_{PR} of the polarization rotation includes the phase rotation amount θ of the polarization rotation as a parameter to be estimated. As illustrated in FIG. 8B, the transfer function H_{PDL} of the polarization dependent loss includes the polarization dependent loss PDL as a parameter to be estimated.

In addition, although not illustrated, the transfer functions H_{fiber1} may selectively include a known transfer function such as a transfer function H_{NL} related to fiber nonlinearity, a transfer function H_{PMD} related to polarization mode dispersion, and a transfer function H_{CD} related to chromatic dispersion. The known transfer function includes, for example, a transfer function of a fiber loss, a transfer function of a dispersion slope, and the like. The transfer function H_{NL}, the transfer function H_{PMD}, and the transfer function H_{CD} all include parameters to be estimated. If all of the known transfer functions used in the optical fiber model, such as the transfer function H_{PR} and the transfer function H_{PDL}, are selected and adopted, the estimation accuracy of the parameter is improved. On the other hand, if a part of the transfer functions used in the optical fiber model is selected and adopted, the calculation amount of the parameter can be reduced, and the power consumption is reduced by suppressing a processing load. In this case, a design value determined in advance may be adopted for the remaining part of the transfer functions.

The optical transmission device model #1 includes a transfer function Hₜᵣₐₙₛ₁ that expresses the characteristics (or states) of the optical transmission device #1 by a mathematical model. The optical transmission device model #1 calculates an output signal of the optical transmission device #1 using the transfer function Hₜᵣₐₙₛ₁. The optical transmission device model #2 and the subsequent optical transmission device models described later are basically the same as the optical transmission device model #1, and thus detailed description thereof will be omitted. As illustrated in FIGS. 8B and 8C, the transfer functions H_{PDL} and H_{filtering} can be selectively adopted as the transfer function Hₜᵣₐₙₛ₁. The transfer function Hₜᵣₐₙₛ₁ may include a transfer function H_{PMD} related to polarization mode dispersion and a transfer function H_{PR} related to polarization rotation. For example, as illustrated in FIG. 8C, a transfer function H_{filtering} of signal band narrowing (hereinafter, referred to as filtering) by an optical filter includes a frequency ω of filtering as a parameter to be estimated. When both the transfer function H_{PDL} and the transfer function H_{filtering} are selected and adopted, the estimation accuracy of the parameter is improved. On the other hand, if the transfer function H_{PDL} is selected and adopted alone, the amount of calculation of the parameter can be reduced, and the power consumption is reduced. In this case, a design value determined in advance may be adopted for the transfer function H_{filtering}.

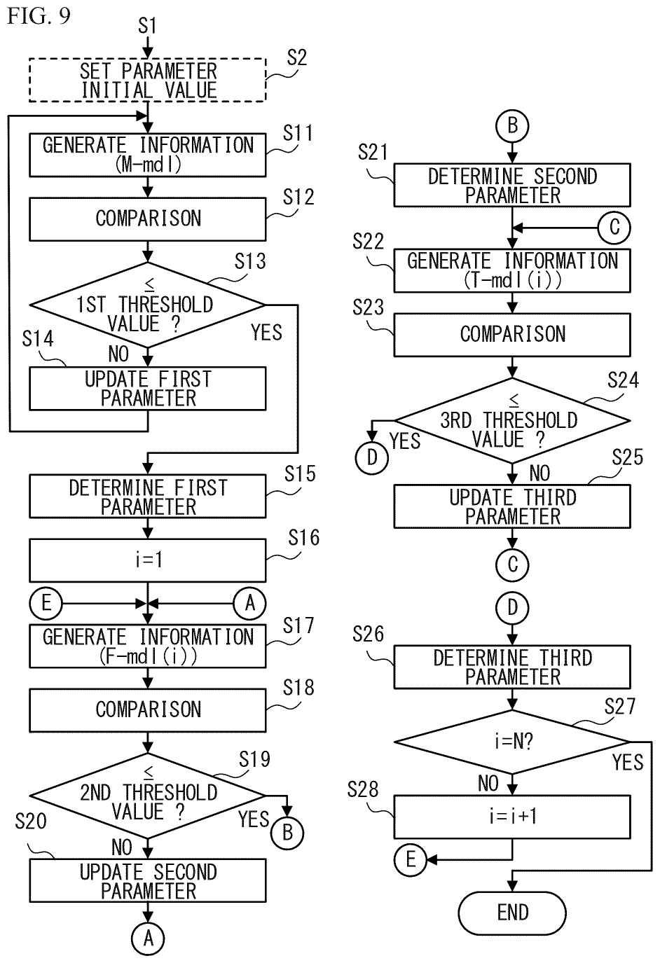

The operation of the optical network management device 100 according to the second example embodiment will be described with reference to FIGS. 9 to 13. The same processes as those in the flowchart described with reference to FIG. 4 are denoted by the same reference numerals, and detailed description thereof will be omitted.

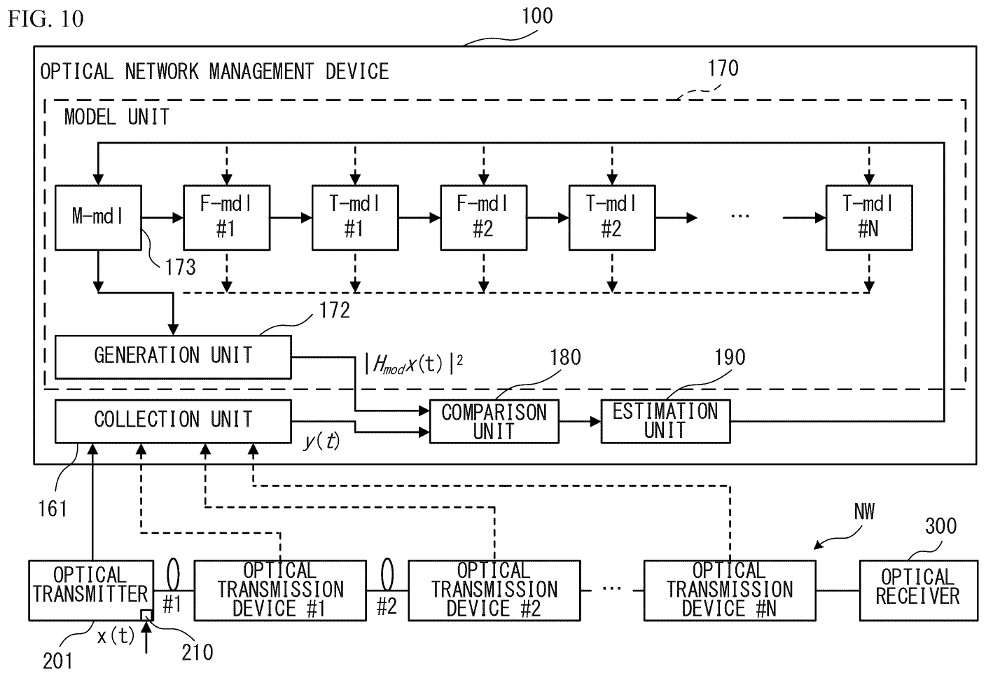

First, as illustrated in FIG. 9, when the process of step S2 described in the first embodiment is completed, the model unit 170 generates the second information based on the optical transmitter model 173 (step S11). More specifically, as illustrated in FIG. 10 (also see FIG. 7), the optical transmitter model 173 generates the electric field information of the virtual signal light corresponding to the signal light output from the optical transmitter 201 based on the data signal x(t), and the generation unit 172 generates the second information based on the electric field information.

When the second information is generated, the comparison unit 180 compares the first information collected from the optical transmitters 201 by the collection unit 161 with the second information generated by the generation unit 172 (step S12), and determines whether a difference between the first information and the second information is equal to or less than a first threshold value (step S13). That is, the determination by the comparison unit 180 can be expressed by the following determination formula (1).

$$< Determination Formula ( 1 ) >$$

$$First information y ( t ) - Second information {\vert {H}_{mod} x ( t ) \vert}^{2} \leq First threahold value {Z}_{th 1}$$

When a difference as the comparison result of the first information y(t) and the second information |H_{mod}x(t)|² is more than the first threshold value Zₜₕ₁ (step S13: NO), the estimation unit 190 updates a first parameter that is a parameter of the transfer function H_{mod} (step S14), and requests the model unit 170 to execute the process of step S11. Accordingly, the model unit 170 generates the second information again using the transfer function H_{mod} including the updated parameter, and the comparison unit 180 compares the first information with the second information. As described above, when there is a deviation larger than the first threshold in the difference between the first information and the second information, the optical network management device 100 repeats the process of updating the parameter until the difference becomes equal to or less than the first threshold value, thereby sufficiently suppressing the deviation.

Then, when the differential as the comparison result of the first information y(t) and the second information |H_{mod}x(t)|² is equal to or less than the first threshold value Zₜₕ₁ (step S13: YES), the estimation unit 190 determines the first parameter (step S15). Hereinafter, the transfer function H_{mod} in which the first parameter is determined will be described as a transfer function H_{mod} fix. In this way, the first parameter updated last can be recognized as a parameter that sufficiently suppresses the deviation between the first information and the second information. The estimation unit 190 can estimate and determine the first parameter of the optical transmitter model 173 by updating the first parameter included in the transfer function of the optical transmitter model 173.

When the first parameter is determined, the model unit 170 sets a number “1” to a variable i (step S16). The variable i corresponds to an identification number of the optical fiber and the optical transmission device. When the number “1” is set to the variable i, the model unit 170 determines the optical fiber #1 and the optical transmission device #1 as the subsequent processing targets. When the number “N” is set to the variable i, the model unit 170 determines the optical fiber #N (not illustrated) and the optical transmission device #N as the subsequent processing objects.

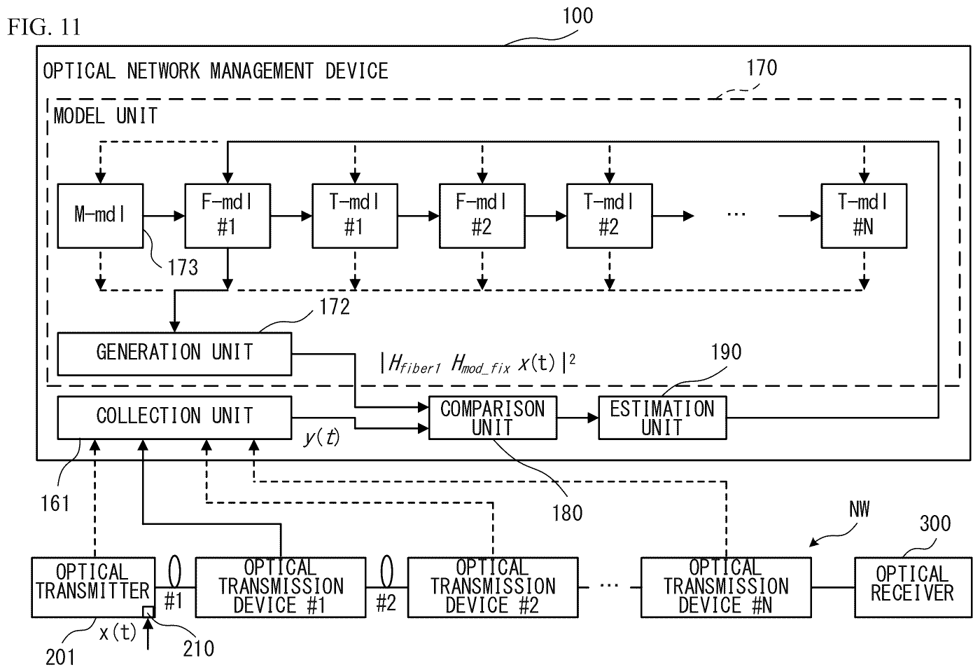

When the number “1” is set to the variable i, the model unit 170 generates the second information based on the optical fiber model #1 (step S17). More specifically, as illustrated in FIG. 11 (also see FIG. 7), the optical fiber model #1 generates the electric field information of the virtual signal light corresponding to the signal light output from the optical fiber #1 based on the electric field information output from the optical transmitter model 173. Then, the generation unit 172 generates the second information based on the electric field information.

When the second information is generated, the comparison unit 180 compares the first information collected from the optical transmission device #1 by the collection unit 161 with the second information generated by the generation unit 172 (step S18), and determines whether a difference between the first information and the second information is equal to or less than the second threshold value (step S19). That is, the determination by the comparison unit 180 can be expressed by the following determination formula (2). When the first information related to the optical fiber #1 is collected from the optical transmission device #1, the brancher 450, the wavelength selection unit 460, and the detection unit 470 described above are arranged immediately before the pre-stage optical amplifier 410 in the optical transmission device #1.

$$< Determination Formula ( 2 ) >$$

$$First information y ( t ) - Second information {\vert {H}_{fiber 1} {H}_{mod \_ fix} x ( t ) \vert}^{2} \leq Second threahold value {Z}_{th 2}$$

When the difference as the comparison result of the first information y(t) and the second information |H_{fiber1}H_{mod_fix}x(t)|² is more than the second threshold value Zₜₕ₂ (step S19: NO), the estimation unit 190 updates a second parameter that is a parameter of the transfer function H_{fiber1} (step S20), and requests the model unit 170 to execute the process of step S17. Accordingly, the model unit 170 generates the second information again using the transfer function H_{fiber1} including the updated parameter, and the comparison unit 180 compares the first information with the second information. As described above, when there is a deviation larger than the second threshold in the difference between the first information and the second information, the optical network management device 100 repeats the process of updating the parameter until the difference becomes equal to or less than the second threshold value, thereby sufficiently suppressing the deviation.

Then, when the difference as the comparison result of the first information y(t) and the second information |H_{fiber1}H_{mod_fix}x(t)|² is equal to or less than the second threshold value Zₜₕ₂ (step S19: YES), the estimation unit 190 determines the second parameter (step S21). Hereinafter, the transfer function H_{fiber1} in which the second parameter is determined will be described as a transfer function H_{mod_fix}x(t). In this way, the second parameter updated last can be recognized as a parameter that sufficiently suppresses the deviation between the first information and the second information. The estimation unit 190 can estimate and determine the second parameter of the optical fiber model #1 by updating the second parameter included in the transfer function of the optical fiber model #1.

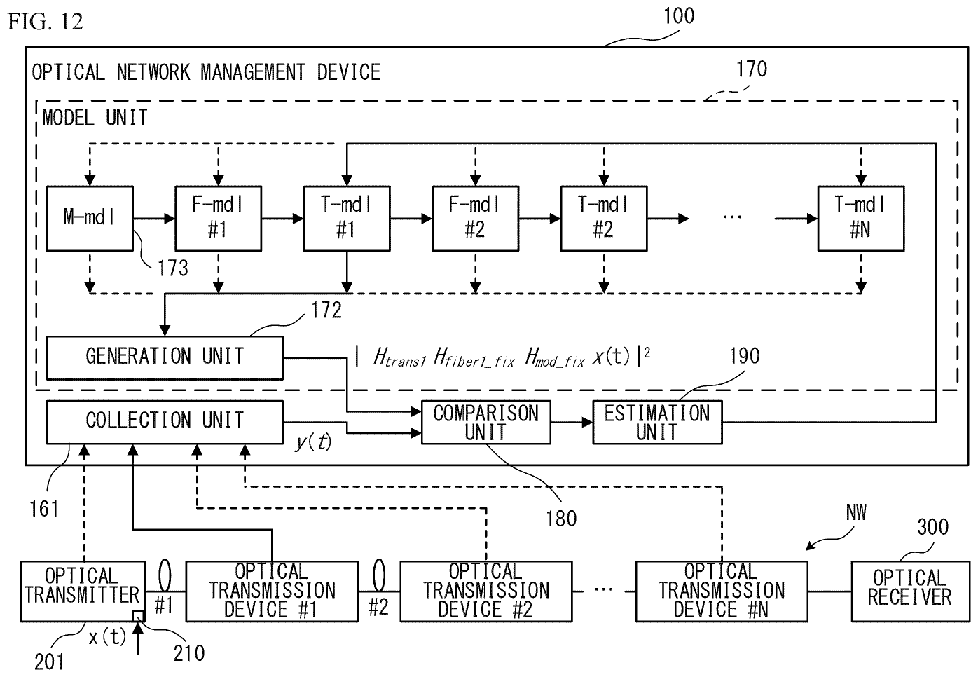

When the second parameter is determined, the model unit 170 generates second information based on the optical transmission device model #1 (step S22). More specifically, as illustrated in FIG. 12 (also refer to FIG. 7), the optical transmission device model #1 generates the electric field information of the virtual signal light corresponding to the signal light output from the optical transmission device #1 based on the electric field information output from the optical fiber model #1. Then, the generation unit 172 generates the second information based on the electric field information.

When the second information is generated, the comparison unit 180 compares the first information collected from the optical transmission device #1 by the collection unit 161 with the second information generated by the generation unit 172 (step S23), and determines whether a difference between the first information and the second information is equal to or less than a third threshold value (step S24). That is, the determination by the comparison unit 180 can be expressed by the following determination formula (3).

$$< Determination Formula ( 3 ) >$$

$$First information y ( t ) - Second information {\vert {H}_{trans 1} {H}_{fiber 1 \_ fix} {H}_{mod \_ fix} x ( t ) \vert}^{2} \leq Third threahold value {Z}_{th 3}$$

When the difference as the comparison result of the first information y(t) and the second information |Hₜᵣₐₙₛ₁H_{fiber1_fix}H_{mod_fix}x(t)|² is more than the third value Zₜₕ₃ (step S24: NO), the estimation unit 190 updates a third parameter that is a parameter of the transfer function Hₜᵣₐₙₛ₁ (step S25), and requests the model unit 170 to execute the process of step S22. Accordingly, the model unit 170 generates the second information again using the transfer function Hₜᵣₐₙₛ₁ including the updated third parameter, and the comparison unit 180 compares the first information with the second information. As described above, when there is a deviation larger than the third threshold value in the difference between the first information and the second information, the optical network management device 100 repeats the process of updating the parameter until the difference becomes equal to or less than the third threshold, thereby sufficiently suppressing the deviation.

Then, when the difference as the comparison result of the first information y(t) and the second information |Hₜᵣₐₙₛ₁H_{fiber1_fix}H_{mod_fix}x(t)|² is equal to or less than the third value Zₜₕ₃ (step S24: YES), the estimation unit 190 determines the third parameter (step S26).

Hereinafter, the transfer function Hₜᵣₐₙₛ₁ in which the third parameter is determined will be described as a transfer function H_{trans1_fix}. In this way, the third parameter updated last can be recognized as a parameter that sufficiently suppresses the deviation between the first information and the second information. The estimation unit 190 may estimate and determine the third parameter of the optical transmission device model #1 by updating the third parameter included in the transfer function of the optical transmission device model #1.

When the third parameter is determined, the model unit 170 determines whether the variable i is a number “N” (step S27). When the variable i is not the number “N” (step S27: NO), the model unit 170 increments the variable i (step S28) and executes the process of step S17. Accordingly, the model unit 170 similarly performs the processes from step S17 to step S26 for the optical fibers #2 and the optical transmission devices #2. If the variable i is the number “N” (step S27: YES), the process is terminated.

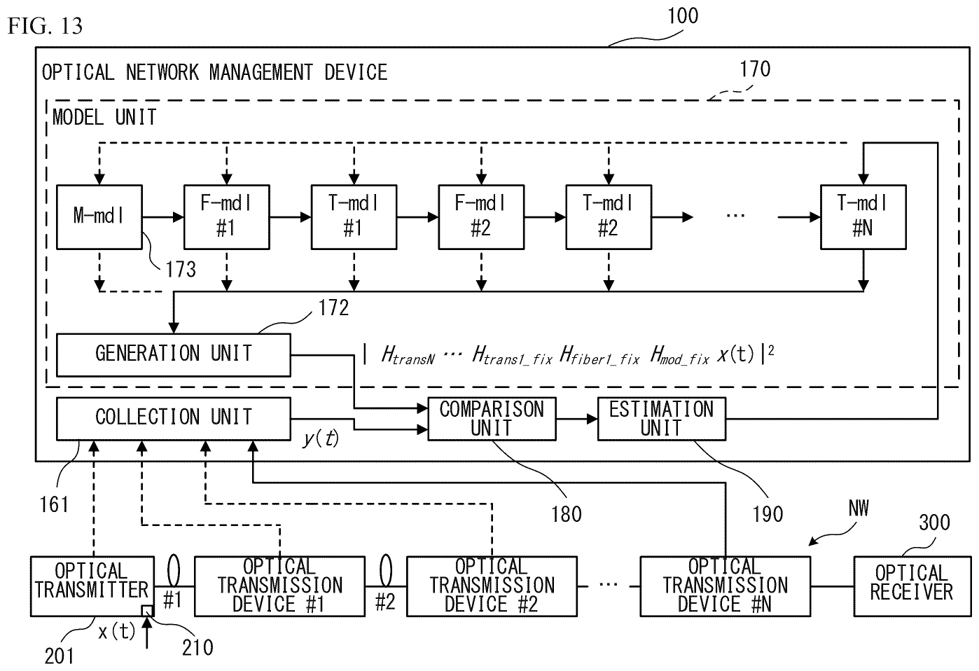

That is, as illustrated in FIG. 13 (also refer to FIG. 7), the comparison unit 180 compares the first information collected from the optical transmission device #N by the collection unit 161 with the second information generated by the generation unit 172, and determines whether a difference between the first information and the second information is equal to or less than an N-th threshold value. In this case, the determination by the comparison unit 180 can be expressed by the following determination formula (4).

First information y(t)−Second information information |H_{transN} . . . H_{trans1_fix}H_{fiber1_fix}H_{mod_fix}x(t)|²≤N-ththreshold value Z_{thN} <Determination Formula (4)>

When a differences as the comparison results with the first information y(t) and the second information |H_{transN} . . . H_{trans1_fix}H_{fiber1_fix}H_{mod_fix}x(t)|² is equal to or less than an N-th threshold value Z_{thN}, the estimation unit 190 determines an N-th parameter and ends the process.

As described above, the optical network management device 100 according to the second embodiment updates the parameter in a stepwise manner from the optical transmitter 201 disposed upstream of the optical network NW to the optical transmission device #N disposed downstream of the optical network NW. More specifically, the optical network management device 100 according to the second example embodiment estimates and determines the parameter of the optical transmitter model, and then estimates and determines the parameter of the optical fiber model and the parameter of the optical transmission device model in a stepwise manner from the upstream to the downstream of the optical network NW for each combination of the optical fiber model and the optical transmission device model. This ensures convergence of parameter update, and improves the estimation accuracy of the parameter compared to the collective update of the optical network model 171 described in the first embodiment. That is, the estimation accuracy of the parameters is improved compared to the first embodiment in which the parameter of an N span is obtained by using the reception waveform of the N-th span alone. As described above, according to the second embodiment, even when the scale of the optical network NW increases and the number of parameters increases, the optical network management device 100 can estimate the parameter with high accuracy and estimate the characteristics of the optical network NW.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

For example, in the actual operation of the optical network NW, a known data signal x(t) designated by an operation manager of the optical network NW and an unknown data signal generated by a customer using the optical network NW may be mixed. In this case, for example, since the optical transmission device #N generates information based on both the known data signal x(t) and the unknown data signal, the collection unit 160 collects this information as the first information. On the other hand, the optical network management device 100 generates the second information by the data signal x(t) alone. This may reduce the accuracy of comparison between the first information and the second information.

Therefore, the optical network management device 100 correlates the first information and the second information before comparing the first information and the second information, extracts the known data signal x(t) from the first information, and compares the information of the extracted data signal x(t) with the second information. Accordingly, even in the actual operation of the optical network NW, the characteristics of the optical network NW can be estimated by updating the parameter.

What is claimed is:

1. An optical network management device comprising:
a collector that collects first information representing a waveform of an intensity of first signal light that is transmitted from an optical transmitter based on input of an electrical data signal and is received by an optical receiver of an optical transmission device via an optical transmission line;
a generator that generates second information representing a waveform of an intensity of virtual second signal light corresponding to the first signal light by calculating electric field information corresponding to the data signal based on the data signal and an optical network model representing a characteristic of an optical network including the optical transmitter, the optical transmission line, and the optical transmission device; and
an estimator that estimates the characteristic of the optical network by calculating a parameter of the optical network model based on the first information and the second information.

2. The optical network management device according to claim 1, further comprising:
a comparator that compares the first information with the second information,
wherein the estimator estimates the characteristic of the optical network by updating the parameter of the optical network model until a comparison result between the first information and the second information becomes equal to or less than a threshold value.

3. The optical network management device according to claim 1,
wherein the optical receiver receives the first signal light having a wavelength that is input to and selected by a wavelength selector of the optical transmission device after a demultiplexer of the optical transmission device demultiplexes signal light.

4. The optical network management device according to claim 1,
wherein the optical receiver is provided in a specific optical transmission device disposed on a most downstream side in the optical network.

5. The optical network management device according to claim 1,
wherein the optical network model includes an optical transmitter model representing a characteristic of the optical transmitter, an optical transmission line model representing a characteristic of the optical transmission line, and an optical transmission device model representing a characteristic of the optical transmission device.

6. The optical network management device according to claim 5,
wherein the estimator estimates and determines a first parameter that is a parameter of the optical transmitter model, estimates and determines a second parameter that is a parameter of the optical transmission line model after estimating and determining the first parameter, and estimates and determines a third parameter that is a parameter of the optical transmission device model after estimating and determining the second parameter, to estimate the characteristic of the optical network.

7. The optical network management device according to claim 5,
wherein a parameter of the optical transmission line model includes any one of polarization rotation, polarization dependent loss, fiber nonlinearity, polarization mode dispersion, chromatic dispersion, fiber loss, and dispersion slope, and
wherein the generator selects at least one of the polarization rotation, the fiber nonlinearity, the polarization mode dispersion, the chromatic dispersion, the polarization dependent loss, the fiber loss, and the dispersion slope to generate the second information.

8. The optical network management device according to claim 5,
wherein a parameter of the optical transmission device model includes any one of polarization dependent loss, signal band narrowing by an optical filter, polarization mode dispersion, and polarization rotation, and
wherein the generator selects at least one of the polarization dependent loss, the signal band narrowing, the polarization mode dispersion, and the polarization rotation to generate the second information.

9. The optical network management device according to claim 1,
wherein the optical network model includes an optical transmitter model representing a characteristic of the optical transmitter, and a plurality of combinations of an optical transmission line model representing a characteristic of the optical transmission line and an optical transmission device model representing a characteristic of the optical transmission device, and
wherein the estimator estimates and determines a first parameter that is a parameter of an optical transmitter model representing a characteristic of the optical transmitter, and then estimates and determines a second parameter that is a parameter of the optical transmission line model and a third parameter that is a parameter of the optical transmission device model in a stepwise manner from upstream to downstream of the optical network for each of the combinations, to estimate the characteristic of the optical network.

10. An optical network management method that causes a computer to execute a process, the process comprising:
collecting first information representing a waveform of an intensity of first signal light that is transmitted from an optical transmitter based on input of an electrical data signal and is received by an optical receiver of an optical transmission device via an optical transmission line;
generating second information representing a waveform of an intensity of virtual second signal light corresponding to the first signal light by calculating electric field information corresponding to the data signal based on the data signal and an optical network model representing a characteristic of an optical network including the optical transmitter, the optical transmission line, and the optical transmission device; and
estimating the characteristic of the optical network by calculating a parameter of the optical network model based on the first information and the second information.

11. The optical network management method according to claim 10,
wherein the estimating includes estimating the characteristic of the optical network by updating the parameter of the optical network model until a comparison result between the first information and the second information becomes equal to or less than a threshold value.

12. The optical network management method according to claim 10,
wherein the optical receiver receives the first signal light having a wavelength that is input to and selected by a wavelength selector of the optical transmission device after a demultiplexer of the optical transmission device demultiplexes signal light.

13. The optical network management method according to claim 10,
wherein the optical receiver is provided in a specific optical transmission device disposed on a most downstream side in the optical network.

14. The optical network management method according to claim 10,
wherein the optical network model includes an optical transmitter model representing a characteristic of the optical transmitter, an optical transmission line model representing a characteristic of the optical transmission line, and an optical transmission device model representing a characteristic of the optical transmission device.
